(19) United States
(12) Patent Application Publication
(10) Pub. No.: US 2017/0018104 A1
(43) Pub. Date: Jan. 19, 2017

(54) DISPLAY CONTROL APPARATUS, DISPLAY CONTROL METHOD, AND NON-TRANSITORY COMPUTER READABLE MEDIUM

(71) Applicant: FUJI XEROX CO., LTD., Tokyo (JP)

(72) Inventor: Tomoyuki SHIMIZU, Kanagawa (JP)

(73) Assignee: FUJI XEROX CO., LTD., Tokyo (JP)

(21) Appl. No.: 15/018,020

(22) Filed: Feb. 8, 2016

(30) Foreign Application Priority Data
Jul. 16, 2015 (JP) 2015-142152

(51) Int. Cl. G06T 11/60; G06T 1/60

(52) U.S. Cl. CPC G06T 11/60; G06T 1/60

(57) ABSTRACT

A display control apparatus includes first and second receiving units, a display, an obtaining unit, a first memory, and a controller. The first receiving unit receives input of a character. The display displays at least one character specified from the input character, as at least one conversion candidate. The second receiving unit receives selection of a single conversion candidate from the at least one displayed conversion candidate. The obtaining unit obtains environment information indicating an environment in which the display control apparatus is being used. The first memory stores a history in which the environment information obtained when the single conversion candidate is selected and the single conversion candidate are associated with each other. The controller controls the display in such a manner that at least one conversion candidate associated, in the history, with environment information different from the environment information obtained when the character is input is not displayed.

### CROSS-REFERENCE TO RELATED APPLICATIONS

This application is based on and claims priority under 35 USC 119 from Japanese Patent Application No. 2015-142152 filed Jul. 16, 2015.

### BACKGROUND

(i) Technical Field

The present invention relates to a display control apparatus, a display control method, and a non-transitory computer readable medium.

(ii) Related Art

In an information processing apparatus which converts an input character into another character string, a technique of displaying conversion candidates for the input character is known.

### SUMMARY

According to an aspect of the invention, there is provided a display control apparatus including a first receiving unit, a display, a second receiving unit, an obtaining unit, a first memory, and a controller. The first receiving unit receives input of a character. The display displays at least one character specified from the input character, as at least one conversion candidate. The second receiving unit receives selection of a single conversion candidate from the at least one displayed conversion candidate. The obtaining unit obtains environment information indicating an environment in which the display control apparatus is being used. The first memory stores a history in which the environment information obtained when the single conversion candidate is selected and the single conversion candidate are associated with each other. The controller controls the display in such a manner that at least one conversion candidate associated, in the history, with environment information different from the environment information obtained when the character is input is not displayed.

### BRIEF DESCRIPTION OF THE DRAWINGS

Exemplary embodiments of the present invention will be described in detail based on the following figures, wherein:

FIG. 1 is a diagram illustrating the functional configuration of a terminal apparatus;

FIG. 2 is a block diagram illustrating the hardware configuration of the terminal apparatus;

FIG. 3 is a flowchart of an operation performed when conversion candidates are displayed;

FIG. 4 is a diagram illustrating an exemplary dictionary table;

FIG. 5 is a diagram illustrating an exemplary history table;

FIG. 6 is a diagram illustrating an exemplary setting table;

FIGS. 7A and 7B are diagrams illustrating exemplary displays of conversion candidates;

FIGS. 8A to 8C are diagrams illustrating other exemplary displays of conversion candidates;

FIG. 9 is a flowchart of an operation performed when the history table is updated; and

FIG. 10 is a diagram illustrating an exemplary setting table.

### DETAILED DESCRIPTION

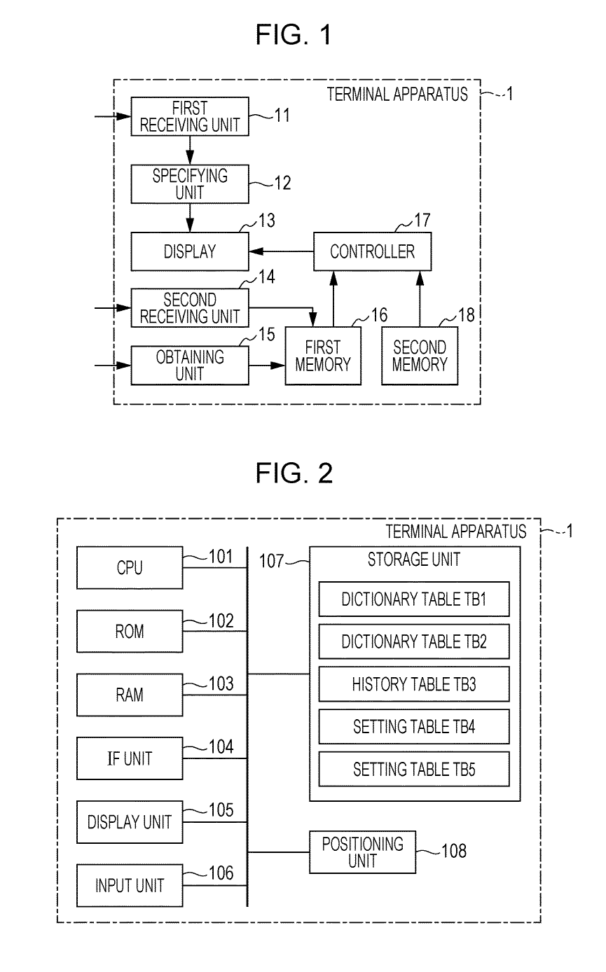

FIG. 1 is a diagram illustrating the functional configuration of a terminal apparatus 1 (exemplary display control apparatus) according to an exemplary embodiment of the present invention. The terminal apparatus 1 displays characters specified from an input character, as conversion candidates. In the description below, if not otherwise specified, a “character” encompasses a string. The terminal apparatus 1 includes a first receiving unit 11, a specifying unit 12, a display 13, a second receiving unit 14, an obtaining unit 15, a first memory 16, a controller 17, and a second memory 18. The first receiving unit 11 receives input of a character. The specifying unit 12 specifies characters corresponding to the input character. The display 13 displays the characters specified by the specifying unit 12, as conversion candidates. The second receiving unit 14 receives selection of one of the displayed conversion candidates. The obtaining unit 15 obtains information indicating an environment in which the terminal apparatus 1 is being used (hereinafter referred to as “environment information”). The first memory 16 is used to store a history in which environment information obtained upon selection of a conversion candidate is associated with the selected conversion candidate. The controller 17 controls the display 13 so that certain conversion candidates are not displayed. The certain conversion candidates which are not displayed are associated with environment information different from that obtained when a character is input, in the history stored in the first memory 16. The second memory 18 is used to store predetermined characters.

FIG. 2 is a block diagram illustrating the hardware configuration of the terminal apparatus 1. The terminal apparatus 1 is a computer having a central processing unit (CPU) 101, a read only memory (ROM) 102, a random access memory (RAM) 103, an interface (IF) unit 104, a display unit 105, an input unit 106, a storage unit 107, and a positioning unit 108. The CPU 101 is a control device which controls the units of the terminal apparatus 1 by executing programs. The CPU 101 reads programs stored in the ROM 102 and the storage unit 107, and executes the programs by using the RAM 103 as a work area. The ROM 102 is a nonvolatile storage device storing various programs and data. The RAM 103 is a main storage device that is volatile and that stores data.

The IF unit 104 which receives/transmits data communicates with an external apparatus via a communication line such as the Internet. The IF unit 104 is provided with a wireless LAN interface and terminals for receiving/transmitting a signal or data from/to an external terminal, such as a video graphics array (VGA) terminal, a Universal Serial Bus (USB) terminal, a wired local-area network (LAN) interface, and a High-Definition Multimedia Interface® (HDMI) terminal.

The display unit 105 is a unit, for example, a liquid-crystal display, which displays information. The input unit 106 which is a device receiving input from a user is provided with a keyboard, a mouse, various buttons, and the like. The input unit 106 may be provided with a touch panel (touch screen) overlying the display of the display unit 105.

The storage unit 107 is an auxiliary storage device that is nonvolatile and that stores various programs and data. In the exemplary embodiment, the storage unit 107 stores a dictionary table TB1, a dictionary table TB2, a history table TB3, a setting table TB4, and a setting table TB5.

The dictionary table TB1 is a table in which a character and its phonetic transcription in kana are stored in such a manner as to be associated with each other. The dictionary table TB1 is referred to so that characters serving as conversion candidates are specified from an input character. Similarly to the dictionary table TB1, the dictionary table TB2 is a table in which a character and its phonetic transcription in kana are stored in such a manner as to be associated with each other. In the dictionary table TB2, a minimal set of characters to be displayed (for example, general words and idioms, commonly-used words and idioms, idiomatic expressions, and fixed phrases), among characters serving as conversion candidates are stored. The dictionary table TB2 is referred to so that characters to be displayed as conversion candidates are selected. In the exemplary embodiment, each of the characters stored in the dictionary table TB2 is stored in the dictionary table TB1. The history table TB3 is a table in which a conversion candidate which was selected and environment information which was obtained when the conversion candidate was selected are stored in such a manner as to be associated with each other. The history table TB3 is referred to so that conversion candidates to be displayed are changed in accordance with an environment in which the terminal apparatus 1 is being used upon input of a character. The history table TB3 is updated when a conversion candidate is selected from displayed conversion candidates. In the history table TB3, in addition to a conversion candidate which was selected, a character which was not selected as a conversion candidate by a user and which was directly input by the user (for example, a character which is not described in a dictionary, such as a technical term or a coined word) is stored in association with environment information which was obtained when the character was input. A specific examples of the dictionary table TB1 and the history table TB3 will be described below.

The setting table TB4 is a table for indicating environment information which serves as a condition for updating the history table TB3 (specifically, for storing a conversion candidate and environment information which are associated with each other). In the setting table TB4, predetermined environment information is stored. The setting table TB5 is a table indicating environment information which serves as a condition for restricting displaying of some of conversion candidates. In the setting table TB5, predetermined environment information is stored. The setting table TB4 and the setting table TB5 are independent of each other, and environment information stored in the setting table TB4 is not necessarily the same as that stored in the setting table TB5. Information in the setting table TB4 and information in the setting table TB5 are changed by a user operating the input unit 106. Specific examples of the setting table TB4 and the setting table TB5 will be described below.

The positioning unit 108 measures the position of the terminal apparatus 1. The positioning unit 108 measures the position of the terminal apparatus 1, for example, by using a global positioning system (GPS). The positioning unit 108 may measure the position of the terminal apparatus 1 by using a method such as base station positioning other than GPS positioning.

In FIG. 2, the input unit 106 controlled by the CPU 101 which executes control programs for controlling the units of the terminal apparatus 1 is an exemplary first receiving unit 11 and an exemplary second receiving unit 14. The CPU 101 which executes the control programs is an exemplary specifying unit 12 and an exemplary controller 17. The display unit 105 controlled by the CPU 101 which executes the control programs is an exemplary display 13. The storage unit 107 controlled by the CPU 101 which executes the control programs is an exemplary first memory 16 and an exemplary second memory 18. The CPU 101 or the positioning unit 108 controlled by the CPU 101 which executes the control programs is an exemplary obtaining unit 15.

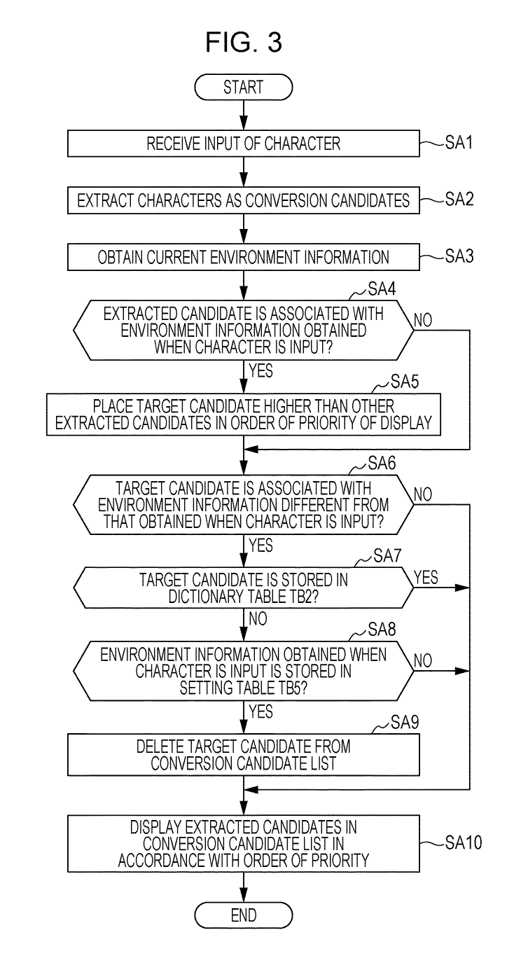

FIG. 3 is a flowchart of an operation performed by the terminal apparatus 1 when conversion candidates are displayed. The process described below is started in a state in which an application program for receiving input of characters, such as a text editor or mail software, has been invoked. In step SA1, the CPU 101 receives user input of a character. The character is input by a user who operates the input unit 106. In step SA2, the CPU 101 extracts characters as conversion candidates for the input character. Specifically, the CPU 101 refers to the dictionary table TB1 and the history table TB3, and extracts characters whose phonetic transcriptions in kana have a character which matches the input character, in the top. The CPU 101 stores a list of extracted characters (hereinafter referred to as a “conversion candidate list”) in the RAM 103.

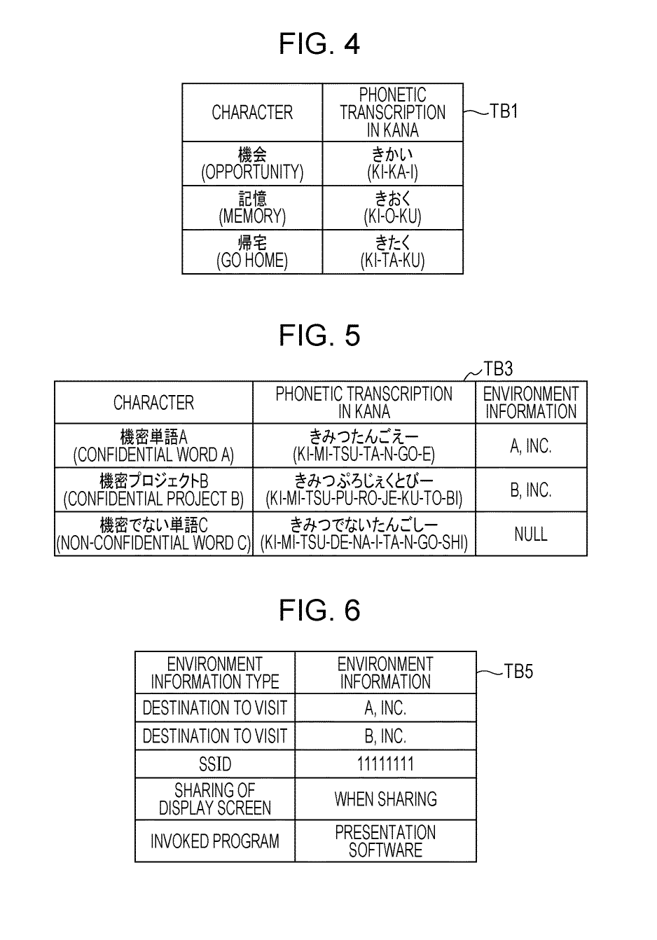

FIG. 4 is a diagram illustrating an exemplary dictionary table TB1. The dictionary table TB1 contains a set of records (rows), each of which is constituted by two fields, “character” and “phonetic transcription in kana”. The field “character” stores a value (data) indicating a word, an idiom, an idiomatic expression, a fixed phrase, or the like. The field “phonetic transcription in kana” stores a value indicating a phonetic transcription in kana which corresponds to the character represented by the record. In FIG. 4, “ [symbol] (opportunity)”, “ [symbol] (memory)”, and “ [symbol] (go home)” are stored as characters corresponding to a hiragana character of “ [symbol] (ki)”. Similarly to the dictionary table TB1, the dictionary table TB2 contains a set of records, each of which is constituted by two fields, “character” and “phonetic transcription in kana”. A specific example of the dictionary table TB2 is not illustrated.

FIG. 5 is a diagram illustrating an exemplary history table TB3. The history table TB3 contains a set of records, each of which is constituted by three fields, “character”, “phonetic transcription in kana”, and “environment information”. The fields “character” and “phonetic transcription in kana” store values similar to those in the dictionary table TB1. The field “environment information” stores a value indicating environment information obtained when the character represented by the record is selected (input). In FIG. 5, “ [symbol] A (confidential word A)”, “ [symbol] B ( confidential project B)”, and “ [symbol] C (non-confidential word C)” are stored. The data “ [symbol] A (confidential word A)” and “ [symbol] B (confidential project B)” are associated with “A, Inc.” and “B, Inc.”, respectively, as environment information. This indicates that, when the terminal apparatus 1 is being used in “A, Inc.”, “ [symbol] A (confidential word A)” is selected (or input), and that, when the terminal apparatus 1 is being used in “B, Inc.”, “ [symbol] B (confidential project B)” is selected (or input). The data “ [symbol] C (non-confidential word C)” is not associated with environment information. This indicates that the environment in which the terminal apparatus 1 is being used when “ [symbol] C (non-confidential word C)” is selected (or input) is different from the environment information indicated in the setting table TB4.

For example, in step SA2, when the dictionary table TB1 illustrated in FIG. 4 and the history table TB3 illustrated in FIG. 5 are referred to for input of a hiragana character of “ [symbol] (ki)”, the conversion candidate list contains “ [symbol] (opportunity)”, “ [symbol] (memory)”, “ [symbol] (go home)”, “ [symbol] A (confidential word A)”, “ [symbol] B (confidential project B)”, and “ [symbol] C (non-confidential word C)”.

Referring back to FIG. 3, in step SA3, the CPU 101 obtains the current environment information. The CPU 101 obtains, for example, the current position of the terminal apparatus 1, the current time, the service set identifier (SSID) of a wireless LAN access point which is being connected to the terminal apparatus 1, an application program (hereinafter referred to as an “invoked program”) which is being invoked in the terminal apparatus 1, information about whether or not the terminal apparatus 1 is being connected to an external apparatus (for example, whether or not the display screen of the terminal apparatus 1 is being shared), or a schedule of a user of the terminal apparatus 1, as environment information. The current position of the terminal apparatus 1 is obtained via the positioning unit 108. The current time is obtained, for example, via a clock included in the terminal apparatus 1. The SSID of the wireless LAN access point is obtained, for example, by reading the SSID stored in advance in the RAM 103. Information about whether or not the terminal apparatus 1 is being connected to an external apparatus is obtained via the IF unit 104. A schedule of the user is obtained, for example, by referring to a schedule stored in advance in the storage unit 107 of the terminal apparatus 1. Thus, in the present exemplary embodiment, environment information is obtained without an operation performed by the user on the terminal apparatus 1. The CPU 101 obtains any one of the above-described pieces of environment information. The obtained environment information may be environment information specified by the user. Alternatively, order of priority may be set in advance for the pieces of environment information, and one of the pieces of environment information may be obtained in accordance with the order of priority. The obtained environment information is not limited to the examples described above. The environment information obtained in step SA3 corresponds to environment information obtained when the character is input.

In step SA4, the CPU 101 determines whether or not a character extracted in step SA2 (hereinafter referred to as an “extracted candidate”) is associated with the environment information obtained when the character is input. Specifically, the CPU 101 refers to the history table TB3, and determines whether or not the extracted candidate is associated with the environment information obtained when the character is input. The processes from step SA4 to step SA8 are performed for each extracted candidate. In the description below, each of the extracted candidates which is a target of the processes from step SA4 to step SA8 is referred to as a “target candidate”. If the CPU 101 determines that the target candidate is associated with the environment information obtained when the character is input (YES in step SA4), the CPU 101 causes the process to proceed to step SA5. If the CPU 101 determines that the target candidate is not associated with the environment information obtained when the character is input (NO in step SA4), the CPU 101 causes the process to proceed to step SA6. For example, assume the following case: the environment information obtained when the character is input is “A, Inc.”; the target candidate is “ [symbol] A (confidential word A)”; and the history table TB3 illustrated in FIG. 5 is referred to. In this case, the CPU 101 determines that “ [symbol] A (confidential word A)” is associated with “A, Inc.” (YES in step SAA). Assume another example as follows: the environment information obtained when the character is input is “A, Inc.”; the target candidate is “ [symbol] B (confidential project B)”; and the history table TB3 illustrated in FIG. 5 is referred to. In this case, the CPU 101 determines that “ [symbol] B (confidential project B)” is not associated with “A, Inc.” (NO in step SAA).

In step SA5, the CPU 101 places the target candidate higher than the other extracted candidates in the order of priority used when the target candidate is displayed. For example, the CPU 101 rearranges the extracted candidates included in the conversion candidate list in accordance with the order of priority. Specifically, the CPU 101 rearranges the extracted candidates in the conversion candidate list so that the target candidate is displayed above the other extracted candidates. Alternatively, by using another method other than the method of rearranging the extracted candidates included in the conversion candidate list, the CPU 101 may store the order of priority for the extracted candidates.

In step SA6, the CPU 101 determines whether or not the target candidate is associated with environment information different from that obtained when the character is input. Specifically, the CPU 101 refers to the history table TB3, and determines whether or not the target candidate is associated with environment information different from that obtained when the character is input. If the CPU 101 determines that the target candidate is associated with environment information different from that obtained when the character is input (YES in step SA6), the CPU 101 causes the process to proceed to step SA7. If the CPU 101 determines that the target candidate is not associated with environment information different from that obtained when the character is input (or that the target candidate is associated with no environment information) (NO in step SA6), the CPU 101 causes the process to proceed to step SA10. For example, assume the following case: the environment information obtained when the character is input is “A, Inc.”; the target candidate is “ [symbol] B (confidential project B)”; and the history table TB3 illustrated in FIG. 5 is referred to. In this case, the CPU 101 determines that “ [symbol] B (confidential project B)” is associated with “B, Inc.” different from “A, Inc.” (YES in step SA6). Assume another case as follows: the environment information obtained when the character is input is “A, Inc.”; the target candidate is “ [symbol] C (non-confidential word C)”; and the history table TB3 illustrated in FIG. 5 is referred to. In this case, the CPU 101 determines that “ [symbol] C (non-confidential word C)” is associated with no environment information (NO in step SA6).

In step SA7, the CPU 101 determines whether or not the target candidate is stored in the dictionary table TB2. The determination in step SA7 is made in order to display a minimal set of conversion candidates to be displayed, in step SA10 described below. If the CPU 101 determines that the target candidate is not stored in the dictionary table TB2 (NO in step SA7), the CPU 101 causes the process to proceed to step SA8. If the CPU 101 determines that the target candidate is stored in the dictionary table TB2 (YES in step SA7), the CPU 101 causes the process to proceed to step SA10.

In step SA8, the CPU 101 determines whether or not the environment information obtained when the character is input is stored in the setting table TB5. If the CPU 101 determines that the environment information obtained when the character is input is stored in the setting table TB5 (YES in step SA8), the CPU 101 causes the process to proceed to step SA9. If the CPU 101 determines that the environment information obtained when the character is input is not stored in the setting table TB5 (NO in step SA8), the CPU 101 causes the process to proceed to step SA10.

FIG. 6 is a diagram illustrating an exemplary setting table TB5. The setting table TB5 is a set of records, each of which is constituted by two fields, “environment information type” and “environment information”. The field “environment information type” stores a value indicating the type of data which is set as environment information, such as the current position, the current time, the SSID, an invoked program, sharing of a display screen, or a destination to visit. The field “environment information” stores a value indicating environment information. In FIG. 6, “A, Inc.” and “B, Inc.” are stored as environment information about a destination to visit; “11111111” is stored as environment information about an SSID; “when sharing” is stored as environment information about sharing of a display screen; and “presentation software” is stored as environment information about an invoked program. For example, assume the following case: the environment information obtained when the character is input is “A, Inc.” indicating a destination to visit; and the setting table TB5 illustrated in FIG. 6 is referred to in step SA8. In this case, the CPU 101 determines that the environment information obtained when the character is input is stored in the setting table TB5 (YES in step SA8). Assume another case as follows: the environment information obtained when the character is input is “22222222” indicating an SSID; and the setting table TB5 illustrated in FIG. 6 is referred to in step SA8. In this case, the CPU 101 determines that the environment information obtained when the character is input is not stored in the setting table TB5 (NO in step SA8).

Referring back to FIG. 3, in step SA9, the CPU 101 deletes the target candidate from the conversion candidate list. The process in step SA9 is performed so as not to display the target candidate in step SA10 described below. In step SA10, the CPU 101 displays the extracted candidates included in the conversion candidate list, in accordance with the order of priority. Specifically, the CPU 101 displays an extracted candidate having a high priority, preferentially to extracted candidates having a low priority, on the display unit 105. The expression “preferentially displayed” indicates that a conversion candidate having a higher priority is displayed in such a manner that a user may select such a conversion candidate through fewer operations. For example, the CPU 101 displays an extracted candidate having a high priority, above extracted candidates having a low priority. The display manner of the extracted candidate is not limited to that described herein.

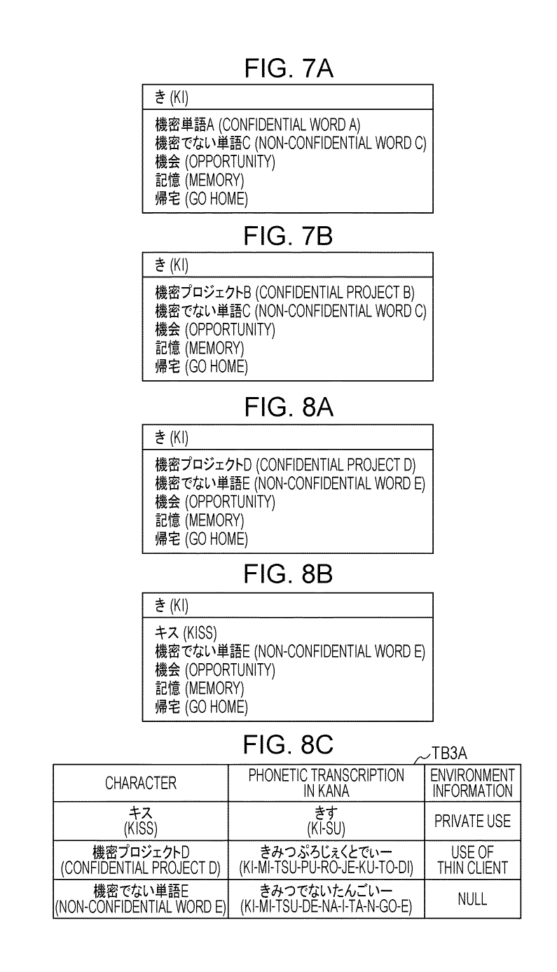

FIGS. 7A and 7B are diagrams illustrating exemplary displays of conversion candidates. FIGS. 7A and 7B illustrate exemplary displays of conversion candidates which are made when the dictionary table TB1 illustrated in FIG. 4, the history table TB3 illustrated in FIG. 5, and the setting table TB5 illustrated in FIG. 6 are stored in the storage unit 107. The description will be made below under assumption that “ [symbol] A (confidential word A)” and “ [symbol] B (confidential project B)” are not stored in the dictionary table TB2.

FIG. 7A illustrates conversion candidates displayed when a user inputs a hiragana character of “ [symbol] (ki)” while the user visits “A, Inc.” When the user inputs a hiragana character of “ [symbol] (ki)”, characters, “ [symbol] (opportunity)”, “ [symbol] (memory)”, “ [symbol] (go home)”, “ [symbol] (confidential word A)”, “ [symbol] B (confidential project B)”, and “ [symbol] C (non-confidential word C)”, are extracted as conversion candidates (step SA2). In addition, “A, Inc.” is obtained as the current environment information, for example, by referring to a schedule stored in advance in the storage unit 107 of the terminal apparatus 1 (step SA3). Since “ [symbol] A (confidential word A)” among the characters extracted as conversion candidates is associated with the environment information “A, Inc.” obtained when the character is input (YES in step SA4), “ [symbol] A (confidential word A)” is placed higher than the other conversion candidates in the order of priority (step SA5). Therefore, “ [symbol] A (confidential word A)” is displayed above the other conversion candidates. In addition, “ [symbol] B (confidential project B)” among the characters extracted as conversion candidates is associated with the environment information “B, Inc.” different from the environment information “A, Inc.” obtained when the character is input (YES in step SA6), and “A, Inc.” is stored in the setting table TB5 (YES in step SA8). Therefore, “ [symbol] B (confidential project B)” is deleted from the conversion candidate list (step SA9). Accordingly, “ [symbol] B (confidential project B)” is not displayed as a conversion candidate.

FIG. 7B illustrates conversion candidates displayed when a user inputs a hiragana character of “ [symbol] (ki)” while the user visits “B, Inc.” When the user inputs a hiragana character of “ [symbol] (ki)”, characters, “ [symbol] (opportunity)”, “ [symbol] (memory)”, “ [symbol] (go home)”, “ [symbol] A (confidential word A)”, “ [symbol] B (confidential project B)”, and “ [symbol] C non-confidential word C)”, are extracted as conversion candidates (step SA2). In addition, “B, Inc.” is obtained as the current environment information, for example, by referring to a schedule stored in advance in the storage unit 107 of the terminal apparatus 1 (step SA3). The character “ [symbol] A (confidential word A)” among the characters extracted as conversion candidates is associated with the environment information “A, Inc.” different from the environment information “B, Inc.” obtained when the characters is input (YES in step SA6), and “B, Inc.” is stored in the setting table TB5 (YES in step SA8). Therefore, “ [symbol] A (confidential word A)” is deleted from the conversion candidate list (step SA9). Accordingly, “ [symbol] A (confidential word A)” is not displayed as a conversion candidate. Since “ [symbol] B (confidential project B)” among the characters extracted as conversion candidates is associated with the environment information “B, Inc.” obtained when the character is input (YES in step SA4), “ [symbol] B (confidential project B)” is placed higher than the other conversion candidates in the order of priority (step SA5). Therefore, “ [symbol] B (confidential project B)” is displayed above the other conversion candidates.

FIGS. 8A to 8C are diagrams illustrating other exemplary displays. FIGS. 8A and 8B illustrate exemplary displays of conversion candidates which are made when the dictionary table TB1 illustrated in FIG. 4 and a history table TB3A illustrated in FIG. 8C are stored in the storage unit 107. Description will be made below under assumption that both of “ [symbol] (kiss)” and “ [symbol] D (confidential project D)” are not stored in the dictionary table TB2. In addition, description will be made under assumption that both of “private use and use of thin client” as environment information are stored in the setting table TB5.

FIG. 8A illustrates conversion candidates displayed when a user inputs a hiragana character of “ [symbol] (ki)” while the user uses the terminal apparatus 1 as a thin client (i.e., in the environment use of thin client“). The environment use of thin client” indicates that the terminal apparatus 1 is being used in a so-called thin client in a broad sense (i.e., a system in which a terminal apparatus performs minimal processing and in which a server performs the remaining processing). When the user inputs a hiragana character of “ [symbol] (ki)”, characters, “ [symbol] (opportunity)”, “ [symbol] (memory)”, “ [symbol] (go home)”, “ [symbol] (kiss)”, “ [symbol] D (confidential project D)”, and “ [symbol] E (non-confidential word E)”, are extracted as conversion candidates (step SA2). The environment information “use of thin client” is obtained as the current environment information, for example, by specifying an invoked program (specifically, specifying that an application program for achieving a thin client is being executed) (step SA3). Since “ [symbol] (kiss)” among the characters extracted as conversion candidates is associated with the environment information “private use different from the environment information use of thin client” obtained when the character is input (YES in step SA6), “ [symbol] (kiss)” is deleted from the conversion candidate list (step SA9). Therefore, “ [symbol] (kiss) ” is not displayed as a conversion candidate. Since “ [symbol] D (confidential project D) ” among the characters extracted as conversion candidates is associated with the environment information “use of thin client” obtained when the character is input (YES in step SA4), “ [symbol] D (confidential project D)” is placed higher than the other conversion candidates in the order of priority (step SA5). Therefore, “ [symbol] D (confidential project D)” is displayed above the other conversion candidates.

FIG. 8B illustrates conversion candidates displayed when a user inputs a hiragana character of “ [symbol] (ki)” while the user uses the terminal apparatus 1 in “private use”. The environment “private use” indicates that the terminal apparatus 1 is being used in an environment other than “use of thin client”. When the user inputs a hiragana character of “ [symbol] (ki)”, characters, “ [symbol] (opportunity)”, “ [symbol] (memory)”, “ [symbol] (go home)”, “ [symbol] (kiss)”, “ [symbol] D (confidential project D)”, and “ [symbol] E (non-confidential word E)”, are extracted as conversion candidates (step SA2). In addition, “private use” is obtained as the current environment information, for example, by specifying an invoked program (specifically, specifying that an application program for achieving a thin client is not being executed) (step SA3). Since “ [symbol] (kiss)” among the characters extracted as conversion candidates is associated with the environment information “private use” obtained when the character is input (YES in step SAA), “ [symbol] (kiss)” is placed higher than the other conversion candidates in the order of priority (step SA5). Therefore, “ [symbol] (kiss)” is displayed above the other conversion candidates. Since “ [symbol] D (confidential project D)” among the characters extracted as conversion candidates is associated with the environment information “use of thin client” different from the environment information “private use” obtained when the character is input (YES in step SA6), “ [symbol] D (confidential project D)” is deleted from the conversion candidate list (step SA9). Therefore, “ [symbol] D (confidential project D)” is not displayed as a conversion candidate.

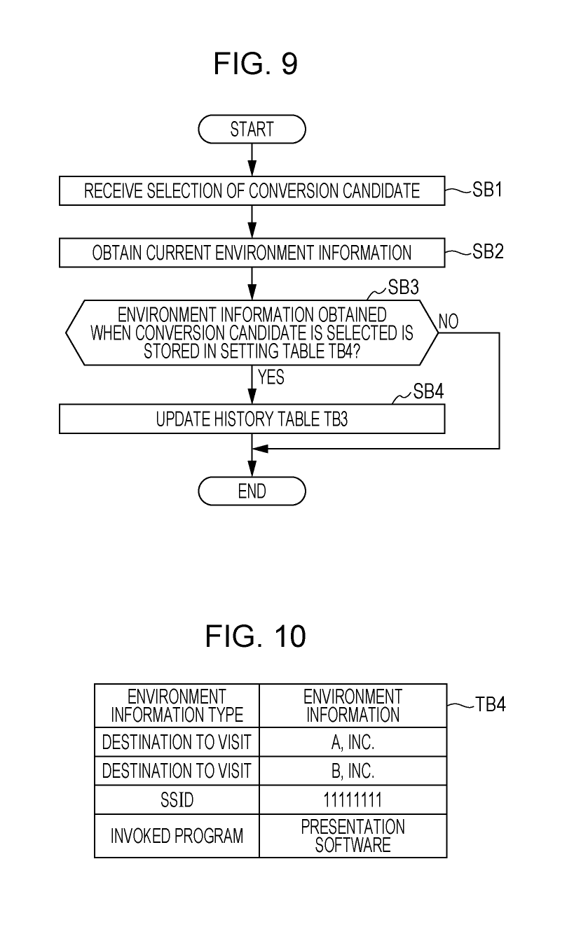

FIG. 9 is a flowchart of an operation performed by the terminal apparatus 1 when the history table TB3 is updated. The process described below is started in a state in which the operation illustrated in FIG. 3 is performed and in which conversion candidates for the input character are displayed on the display unit 105. In step SB1, the CPU 101 receives selection of a conversion candidate from the conversion candidates displayed on the display unit 105. A conversion candidate is selected by a user operating the input unit 106. In step SB2, the CPU 101 obtains the current environment information. The CPU 101 obtains the current environment information by a method similar to that in step SA3 described above. The environment information obtained in step SB2 corresponds to the environment information obtained when the conversion candidate is selected. The process in step SB2 is not necessarily performed. The environment information obtained in step SA3 described above may be used as the environment information obtained when the conversion candidate is selected.

In step SB3, the CPU 101 determines whether or not the environment information obtained when the conversion candidate is selected is stored in the setting table TB4. If the CPU 101 determines that the environment information obtained when the conversion candidate is selected is stored in the setting table TB4 (YES in step SB3), the CPU 101 causes the process to proceed to step SB4. If the CPU 101 determines that the environment information obtained when the conversion candidate is selected is not stored in the setting table TB4 (NO in step SB3), the CPU 101 ends the process.

FIG. 10 is a diagram illustrating an exemplary setting table TB4. Similarly to the setting table TB5, the setting table TB4 contains a set of records, each of which is constituted by two fields, “environment information type” and “environment information”. In FIG. 10, “A, Inc.” and “B, Inc.” are stored as environment information about a destination to visit; “11111111” is stored as environment information about an SSID; and “presentation software” is stored as environment information about an invoked program. For example, assume the following case: the environment information obtained when the conversion candidate is selected is “A, Inc.”; and the setting table TB4 illustrated in FIG. 10 is referred to in step SB3. In this case, the CPU 101 determines that the environment information obtained when the conversion candidate is selected is stored in the setting table TB4 (YES in step SB3). Assume another case as follows: the environment information obtained when the conversion candidate is selected is an SSID of “22222222”; and the setting table TB4 illustrated in FIG. 10 is referred to in step SB3. In this case, the CPU 101 determines that the environment information obtained when the conversion candidate is selected is not stored in the setting table TB4 (NO in step SB3).

Referring back to FIG. 9, in step SB4, the CPU 101 updates the history table TB3. Specifically, the CPU 101 registers the conversion candidate selected in step SB1 and the environment information obtained when the conversion candidate is selected, in the history table TB3 in such a manner that the selected conversion candidate and the obtained environment information are associated with each other. When the selected conversion candidate is already stored in the history table TB3, the CPU 101 adds the environment information obtained in step SB2 to the environment information which is already associated with the conversion candidate in the history table TB3.

The process described above achieves prevention of occurrence of a state in which a character selected while the terminal apparatus 1 is used in a certain environment (for example, a word which a user does not want other people to view, such as a word describing a business secret or a word describing privacy) is displayed as a conversion candidate when the terminal apparatus 1 is used in another environment. Since the order of priority used when conversion candidates are displayed is changed in accordance with the history of user's selection of a conversion candidate in the past, usability obtained when a conversion candidate is selected is improved compared with a case in which conversion candidates are displayed in predetermined order.

An exemplary embodiment of present invention is not limited to the above-described exemplary embodiment. Various modifications may be made and be carried out. Some modified exemplary embodiments will be described below. Two or more exemplary embodiments among the modified exemplary embodiments described below may be combined so as to be used.

Acquisition of environment information in step SA3 does not need to be performed every time a character is input. The CPU 101 may obtain environment information, for example, in accordance with an instruction from a user. In another example, the CPU 101 may obtain new environment information every time a predetermined time elapses. Similarly, acquisition of environment information in step SB2 does not need to be performed every time selection of a conversion candidate is received.

Acquisition of environment information is not limited to the case in which the acquisition is performed without an operation performed by a user on the terminal apparatus 1. Environment information may be input, for example, by a user operating the terminal apparatus 1.

A character associated with the environment information obtained when a character is input, in the history table TB3 does not need to be displayed preferentially to the other characters. In this case, the processes in step SA4 and step SA5 are skipped. In step SA10, the CPU 101 displays the extracted candidates included in the conversion candidate list in predetermined order (such as the ascending order, the descending order, or the ascending order of the count in which a candidate was selected).

Data stored in the dictionary table TB1, the dictionary table TB2, the history table TB3, the setting table TB4, and the setting table TB5 may be stored in the storage unit 107 in another form other than a table.

The history table TB3 may be updated through a process other than the process described in the exemplary embodiment. The history table TB3 may be directly edited by a user. For example, a user may register a new association between a character and environment information, may delete environment information associated with a character, and may associate new environment information with a character which is already registered in the history table TB3. The terminal apparatus 1 may have a function of displaying a list of characters associated with certain environment information in the history table TB3 and receiving a change of the association between a character and the environment information.

The configuration of the terminal apparatus 1 is not limited to that described in the exemplary embodiment. The terminal apparatus 1 may be, for example, a tablet terminal having a touch panel.

In the exemplary embodiment, control programs executed by the terminal apparatus 1 may be provided by storing the programs in a computer-readable recording medium, such as a magnetic recording medium (for example, a magnetic tape or a magnetic disk, such as a hard disk drive (HDD) or a flexible disk (FD)), an optical recording medium (for example, an optical disk, such as a compact disk (CD) or a digital versatile disk (DVD)), a magneto-optical recording medium, or a semiconductor memory (for example, a flash ROM). These programs may be downloaded via a network such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control apparatus comprising:
a first receiving unit that receives input of a character;
a display that displays at least one character specified from the input character, as at least one conversion candidate;
a second receiving unit that receives selection of a single conversion candidate from the at least one displayed conversion candidate;
an obtaining unit that obtains environment information indicating an environment in which the display control apparatus is being used;
a first memory that stores a history in which the environment information obtained when the single conversion candidate is selected and the single conversion candidate are associated with each other; and
a controller that controls the display in such a manner that at least one conversion candidate associated, in the history, with environment information different from the environment information obtained when the character is input is not displayed.

2. The display control apparatus according to claim 1,
wherein the controller controls the display in such a manner that a conversion candidate associated, in the history, with the environment information obtained when the character is input is displayed preferentially to other conversion candidates.

3. The display control apparatus according to claim 1,
wherein the obtaining unit obtains the environment information without an operation performed by a user on the display control apparatus.

4. The display control apparatus according to claim 2,
wherein the obtaining unit obtains the environment information without an operation performed by a user on the display control apparatus.

5. The display control apparatus according to claim 1, further comprising:
a second memory that stores a predetermined character,
wherein the controller controls the display in such a manner that the character which is stored in the second memory and which is among the at least one conversion candidate associated, in the history, with the environment information different from the environment information obtained when the character is input is displayed.

6. The display control apparatus according to claim 2, further comprising:
a second memory that stores a predetermined character,
wherein the controller controls the display in such a manner that the character which is stored in the second memory and which is among the at least one conversion candidate associated, in the history, with the environment information different from the environment information obtained when the character is input is displayed.

7. The display control apparatus according to claim 3, further comprising:
a second memory that stores a predetermined character,
wherein the controller controls the display in such a manner that the character which is stored in the second memory and which is among the at least one conversion candidate associated, in the history, with the environment information different from the environment information obtained when the character is input is displayed.

8. The display control apparatus according to claim 4, further comprising:
a second memory that stores a predetermined character,
wherein the controller controls the display in such a manner that the character which is stored in the second memory and which is among the at least one conversion candidate associated, in the history, with the environment information different from the environment information obtained when the character is input is displayed.

9. The display control apparatus according to claim 1,
wherein, in the case where the environment information obtained when the single conversion candidate is selected is predetermined environment information, the first memory stores the environment information and the single conversion candidate in such a manner that the environment information and the single conversion candidate are associated with each other.

10. The display control apparatus according to claim 2,
wherein, in the case where the environment information obtained when the single conversion candidate is selected is predetermined environment information, the first memory stores the environment information and the single conversion candidate in such a manner that the environment information and the single conversion candidate are associated with each other.

11. The display control apparatus according to claim 3,
wherein, in the case where the environment information obtained when the single conversion candidate is selected is predetermined environment information, the first memory stores the environment information and the single conversion candidate in such a manner that the environment information and the single conversion candidate are associated with each other.

12. The display control apparatus according to claim 4,
wherein, in the case where the environment information obtained when the single conversion candidate is selected is predetermined environment information, the first memory stores the environment information and the single conversion candidate in such a manner that the environment information and the single conversion candidate are associated with each other.

13. The display control apparatus according to claim 5,
wherein, in the case where the environment information obtained when the single conversion candidate is selected is predetermined environment information, the first memory stores the environment information and the single conversion candidate in such a manner that the environment information and the single conversion candidate are associated with each other.

14. The display control apparatus according to claim 6,
wherein, in the case where the environment information obtained when the single conversion candidate is selected is predetermined environment information, the first memory stores the environment information and the single conversion candidate in such a manner that the environment information and the single conversion candidate are associated with each other.

15. The display control apparatus according to claim 7,
wherein, in the case where the environment information obtained when the single conversion candidate is selected is predetermined environment information, the first memory stores the environment information and the single conversion candidate in such a manner that the environment information and the single conversion candidate are associated with each other.

16. The display control apparatus according to claim 8,
wherein, in the case where the environment information obtained when the single conversion candidate is selected is predetermined environment information, the first memory stores the environment information and the single conversion candidate in such a manner that the environment information and the single conversion candidate are associated with each other.

17. The display control apparatus according to claim 1,
wherein, in the case where the environment information obtained when the character is input is predetermined environment information, the controller controls the display in such a manner that the at least one conversion candidate associated, in the history, with the environment information different from the environment information obtained when the character is input is not displayed.

18. A non-transitory computer readable medium storing a program causing a computer to execute a process for a display control apparatus, the process comprising:
receiving input of a character;
displaying at least one character specified from the input character, as at least one conversion candidate;
receiving selection of a single conversion candidate from the at least one displayed conversion candidate;
obtaining environment information indicating an environment in which the display control apparatus is being used;
storing a history in which the environment information obtained when the single conversion candidate is selected and the single conversion candidate are associated with each other; and
exerting control in such a manner that at least one conversion candidate associated, in the history, with environment information different from the environment information obtained when the character is input is not displayed.

19. A display control method for a display control apparatus, the method comprising:
receiving input of a character;
displaying at least one character specified from the input character, as at least one conversion candidate;
receiving selection of a single conversion candidate from the at least one displayed conversion candidate;
obtaining environment information indicating an environment in which the display control apparatus is being used;
storing a history in which the environment information obtained when the single conversion candidate is selected and the single conversion candidate are associated with each other; and
exerting control in such a manner that at least one conversion candidate associated, in the history, with environment information different from the environment information obtained when the character is input is not displayed.
